(19) United States
(12) Patent Application Publication
(10) Pub. No.: US 2009/0061975 A1
(43) Pub. Date: Mar. 5, 2009

(54) Video poker bonus hands wagering system

(76) Inventor: Dimo Ditchev, Reno, NV (US)

Correspondence Address: KNECHTEL, DEMEUR & SAMLAN, 525 W. MONROE STREET, SUITE 2360, CHICAGO, IL, 60661, US

(21) Appl. No.: 12/072,192

(22) Filed: Feb. 25, 2008

Related U.S. Application Data
(60) Provisional application No. 60/966,933, filed on Aug. 30, 2007.

(51) Int. Cl. A63F 13/00

(52) U.S. Cl. 463/13

(57) ABSTRACT

A multitier video poker game that is played by a single player which displays a first tier compulsory base poker hand and optional tiered bonus poker hands. The base poker hand is a traditionally played five card draw video poker hand, where the player makes a wager prior to the hand being dealt to him, and his final hand is evaluated against a prior stipulated pay schedule. After playing this hand the player is provided with an option to wager on additional tiers of bonus poker hands which are dealt face up from independent standard decks. The game dynamically calculates or searches in a pre-calculated and statically stored lookup table the probability of all possible hands in respect to the bonus poker hands and assigns awards to the set of predefined winning hand categories so that all possible hold strategies are available and converge to a desired hold percentage. The payout schedule and the optimal payback percentage are displayed to the player to facilitate his decision whether to wager or not on a bonus poker hand. Every subsequent bonus poker hand offers better odds to the player than the previously played hand.

### CROSS-REFERENCE TO RELATED APPLICATIONS

This application is based on and claims priority of provisional patent application 60/966,933 filed Aug. 30, 2007.

### I. BACKGROUND OF THE INVENTION

Video poker has achieved such great popularity as a gaming entertainment game that it has been called “America's National Game of Chance”. An analysis of the underlying reasons that made this game so famous to the American public in an attempt to design a new tool for entertainment yields the following features:
The inventive game provides a fair return to the player. The game offers a competitively high payback percentage that is in the mid to high ninety percent ranges as compared to other computerized casino games.
The inventive game prominently displays the payback to the player. The payoff schedule, hereinafter referred to as the “Contract” to the player, is clearly and conspicuously displayed to the player. As the experienced player is knowledgeable to the probabilities of the winning hands, he can deduce the underlying payback percentage of the game and knows what he is wagering for.
The game rewards the skill of the player. Some skill from the player influences the payback percentage in the range of 1-2%. Therefore the game provides improved reward to the player for playing better and improving his skills. This experience can be achieved either by studying the theory of probabilities, or by practicing on non-wagering computer program, or by the far more entertaining method of gambling.
The game is profitable to the gaming establishment. For the casino, where the compliment of the payback percentage to 100%, known as the house hold percentage, a range of 1-2% for “teaching the players how to play video draw poker” is unique compared to other computerized games, like the slot games, or even the table games, where the casino does not create any revenue when providing lessons to teach the patrons how to play the games. Compared to an average hold percentage on video poker games of around 5%, 1 to 2% accrues almost an additional 40% to the casino while the patrons are learning the poker games.
In a casino environment, the game allows the players to oftentimes observe a jackpot winning hand. In a game cycle, it is possible for the players to verify if a game has been “rigged”. A royal flush statistically occurs approximately once in every 40,000 hands. If we assume an average duration of 2.2 seconds per game, which equals 88,000 seconds, a Royal Flush is due once in every 24.44 hours of continuous play on a single machine. Although such a physical observation would be hard for a normal human being to carry out in observing a single machine, it is still possible to observe a Royal Flush about once every hour in a casino with an area of 25 poker machines.

Still, playing the same game over and over may become boring, so casino game operators with the help of casino game manufactures try to keep poker players entertained by introducing new and more intriguing derivatives to the traditional video draw poker games. These developments more or less fall in the following three major groups:
GAMBLE: After a winning game the player is offered to wager his win on a cascade of optional features with no advantage to the house, where he selects a single card from a plurality and compares it to a house card.
MULTIPLE DECKS: Drawing simultaneously cards from multiple independent decks without changing the rules of the initial game, like in the well-known games to those skilled in the art. One example is “Multi-Play Draw Poker” in which the dealt cards are duplicated, but the players makes a wager for each deck prior to the cards being dealt face up; also the player can select to hold cards only in one deck, and the rest of the decks duplicate his chosen hold strategy. Another example is “Multi-Tier (Maniac) Poker” in which after the player plays a compulsory poker hand, if he wins, he is allowed to bet all or part of his winnings on additional hands from independent standard decks. Still another is “Multi-Strike Poker” in which the wagers are made on successive stages of the multi-stage game and each stage may have its own paytable and its own expected return, but it depends on the outcomes of the stages and not on the player's decision to proceed to the next stage. Furthermore a bet made on a stage of the game which is not played is lost in the preferred form of the game. In “Guaranteed Play Poker” the player buys in a guaranteed pool of independent hands to play at a fixed price independent of the outcomes of these games and his credit meter may go negative. In “Opponents Poker” the player bets and competes in the draw against two other players that are dealt exactly the same cards from independent decks. In all of these games the same advantage is given to the house as the originating game.
NEW PLAY STRATEGIES: New games with new set of rules, such as “Deuces Wild” in which deuces can represent any card in the deck in a winning combination, “Bonus Draw Poker” in which the four of a kind are differentiated by rank and pay bigger than regular prizes, “Double Bonus Draw Poker” in which the four of a kind are differentiated by rank and pay even bigger prizes, “Double Double Bonus Poker” in which some four of a kind pay really big prizes, “Second Chance Poker” in which after the draw the player can bet and draw additional cards to improve his final hand, “Caribbean Stud” in which the player competes against a dealer hand, and “Let-it-Ride” in which the player can increase his bet after the first 3 cards are revealed, with any legal hold percentage in a regulated jurisdiction.

The clear winners among the above are the “Multi-Play (Triple, Five or more) Poker”, “Double Double Bonus Poker” and “Multi-Strike Poker” as one can still see them played in any casino. Obvious losers are “Double Up”, “Hi-Lo” and “Beat the Dealer” as it will be very hard for anyone to find them in a casino environment.

Analyzing the do's and don'ts in the above winners and losers and their kins in the past two decades or so of video poker games, the clear message from the players is they:
like to have a final goal such as knowing what they are playing as illustrated by a clear Contract;
like a multitude of options to achieve that goal;
like to make decisions on how to achieve the goal;
like that stupidity is costly (like throwing away a dealt Royal Flush or holding a loser hand);
like better odds;
like to play preferably more poker hands;
like duplicated dealt hands;
don't like plain gambling;
don't like a cut in the base poker pay back percentage in lieu of a bonus feature;
don't like complicated and obscured rules;
don't like a long learning curve;
don't like non-poker additions to the game.

### II. SUMMARY OF THE INVENTION

The present invention relates to a single player casino style draw video poker game incorporating multiple bonus poker tiers and options for the player to make multiple additional wagers on these bonus draw poker tiers with more fair or favorable odds to him than the base draw poker tier.

The current invention is aimed to provide a sound solution to the players demand for a new video poker game utilizing the contemporary advancements in computer technology and software science. The game according to this invention, hereinafter called True Odds Poker (“TOP”), is designed to be played on a single player computerized video gaming device. Two or more decks of standard fifty-two card decks are used in a multi-tier poker game with traditionally established poker rankings. After playing a well-known compulsory Base Poker Hand tier, with the final hand evaluated according to a posted traditional Contract (payoff schedules) and awarded, the player is provided an option to wager and play additional Bonus Poker Hands tiers, with odds that are independent from the Base Poker Hand tier.

The novelty of the approach in the new Bonus Poker Hand tiers is that the dealt cards are displayed face up to the player (the initial condition) prior to the player placing a wager and the Contracts are evaluated by the computer in real time (or retrieved from a previously stored lookup table) in respect to the probabilities of all possible 2,598,960 final hands and the desired payback percentage. In order to entice the player to play the Bonus Poker Hand tiers, the desired payback percentage is preferably greater for the player in the Bonus Poker Hand tiers than in the Base Poker Hand tier.

This approach has become implemental based on the most recent advances in computer technology:
Casino Electronic Gaming Devices (“EGM”) have been overhauled from 40 MHz to the GHz domain and are assisted by fast Radion and Nvidia video cards.
The storage media for the programs have skyrocketed from 256 KB chips to 2 GB hard drives. As an alternative to the real time computation of the probabilities it is also feasible to pre-compile all possible unique hands and Contracts into a huge static lookup table and store it on a hard drive.
Tremendous improvements have been achieved in computer science in designing more advanced algorithms for evaluating poker hands. Today's computer can perform all the operations required to evaluate the 2,598,960 hands within less than one second.

These advances make it possible for the EGM to calculate the probabilities of all 2,598,960 hands for any starting five card game (the initial condition), or retrieve the appropriate Contract and payback percentage from precompiled and stored data in far less time than the human time limitations over playing a traditional draw video poker game, but today's EGM still do little more to entertain the players than flipping up to 10 cards on the screen. Using dynamically or statically generated Contracts and payback percentage is entirely transparent to the player and makes no difference to the entertainment value of the game. The manufacturer is free to choose the more efficient implementation at the time.

The invention creates new initial condition to the traditional poker game as the cards in the initially dealt Bonus Poker Hand tiers are revealed to the player prior to his decision to wager. The five cards in the Bonus Poker Hand tiers that are revealed to the player prior to his wager could be the initially dealt five cards, or the five cards of the final hand of the Base Poker tier. They very well could be any five card combination of the retrieved up to ten cards in the Base Poker Hand tier depending on the number of cards held by the player, or even any randomly selected five cards of the employed deck. This will only change the initial conditions; while there will be always 2,598,960 hands in a 52 card standard deck and always 7,462 unique poker hands. These finite conditions provide the necessary and sufficient mathematical background for the computer implementation of the new Poker game.

The invention creates a multitude of new strategies to the poker players. The complete calculation of the probabilities for all 7,462 unique initial poker hands, multiplied by the 32 possible ways to hold any five cards, generates a multitude of new strategies to the player to achieve his final goal. The different formats of the Bonus Poker hand, like in “Deuces Wild” and “Bonus Draw Poker”, will only influence the strategies due to the different number of winning combination (final conditions) and set of rules to play. By allocating awards that strive to yield a payback percentage as close to the desired one as possible, it will introduce more competitiveness to the new poker game strategies and offer more than one to the player with very close payback percentage. For example, if the player has bet five credits and was dealt a wining pair of Jacks, after calculating the true odds of the initially dealt hand, the computer may be able to award any winning pair in the final hand 1, 2, 3 or 4 credits, based on the probabilities of the final winning categories. As far as some trivial initial hands like a dealt Royal Flush or hands in which the optimal hold strategies are not obvious to the player, let's not forget that the player's wager is optional, and that the poker players don't mind if they are penalized for playing stupidly. Therefore the player will be able to choose among more than one optimally close strategy to achieve his final goal and this is strongly believed to add more entertainment value in the Bonus Poker Hand tiers.

The inventive game design also takes in consideration that the poker players are reluctant to defer awards from the Base Poker Hand tier to finance any Bonus Poker Hand tiers (like for example in the “Triple Trouble Poker”). The Bonus Poker Hand tiers are financed by the additional wager that the player can opt to make or forgo, upon his evaluation of the revealed hand and the payback percentage, solely upon his decision. The only way the player is enticed into playing the Bonus Poker hand tiers is the higher average return that he is offered, and the entertainment value. The better pay back percentage of the Bonus Poker hand tiers is clearly displayed to the player so he knows what he plays for as in any traditional Draw Poker game. As you get what you see in the new game, the player will reject to wager on Bonus Poker Hand tiers which he considers dull, or too risky or not more advantageous (for whatever reason) than the Base Poker Hand tier and can directly proceed to the next game.

The distinguished features of the present invention as described are:
(a) Entertainment value: The invention creates new and more competitive strategies for the player to achieve his goals. He is able to make more and new decisions compared to the traditional Draw Poker games, for example to wager on the Bonus Poker Hand tiers and explore new caveats of the Poker game.
(b) Fair odds: The regulatory body can verify that the computer algorithm asserts that the Contract posts the true odds of the Bonus Poker hand tiers to the player.
(c) Profitability: In addition to the house advantage in the Base Poker Hand tier about which the player is well aware, the house is assured of minimum hold percentage in the Bonus Poker Hand tiers. Also extrapolating on the history of the Video Draw Poker it can be asserted, that the operator will earn an additional 1 to 2% while players are exploring and learning the new strategies.

Furthermore, in the general case neither of the dealt Bonus Poker Hand tiers need to be unique (they can very well duplicate the Base Poker Hand tier expanding on the success of the Multi Play Poker game), nor does their format needs to be the same as the Base Poker Hand tier (i.e. “Jacks or Better”, “Deuces Wild” or “Double Draw Poker”). Any combination of the above games can be implemented in the Bonus Poker Hand tiers with the appropriate Contracts in the overall framework of the TOP game. The mathematical background of the current invention is flexible enough to accommodate all of these variations. The final successful embodiments will be determined only by the players demand.

### III. DESCRIPTION OF THE DRAWINGS

FIG. 1 is a display of the video screen after the player places his or her wager on the Base Poker Hand.

FIG. 2 is a display of the video screen after the cards of the Base Poker Hand are dealt and displayed face up.

FIG. 3 is a display of the video screen after the Base Poker Hand is played to conclusion.

FIG. 4 is a display of the video screen after the first Bonus Poker Hand is displayed.

FIG. 5 is a display of the video screen after the player has made a wager on the first Bonus Poker Hand.

FIG. 6 is a display of the video poker screen after the first Bonus Poker Hand has been played to conclusion and the second Bonus Poker Hand is displayed.

FIG. 7 is a display of the video poker screen after the player has made a wager on the second Bonus Poker Hand.

FIG. 8 is a display of the video poker screen after the second Bonus Poker Hand has been played to conclusion.

FIG. 9 is a display of the odds of achieving a specific hand for each hold pattern of the cards in the first Bonus Poker Hand.

FIG. 10 is a display of the odds of achieving a specific hand for each hold pattern of the cards in the second Bonus Poker Hand.

FIG. 11 is a flow chart of the computer program of the inventive wagering system.

### IV. DESCRIPTION OF THE PREFERRED EMBODIMENT

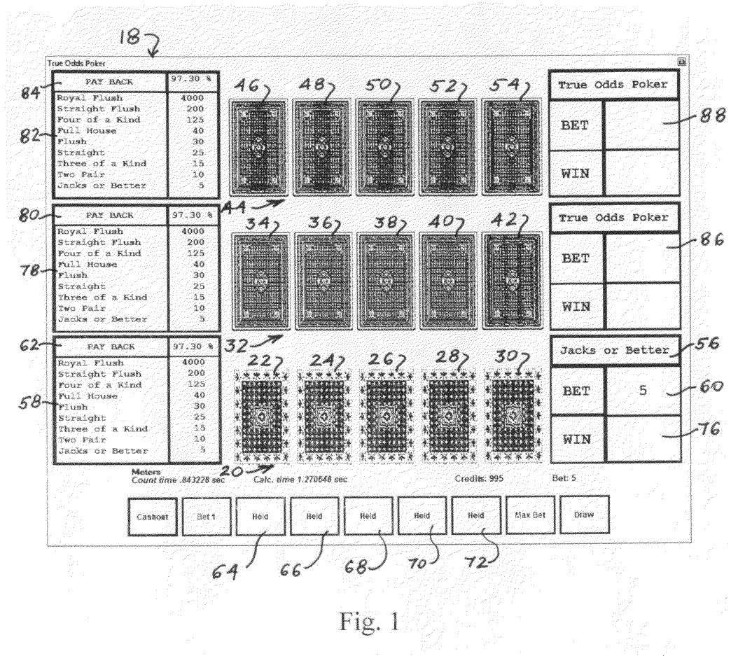

Turning first to FIG. 1 there is illustrated one embodiment of the invention. There is displayed on a video monitor 18 a Base Poker Hand 20 that is comprised of five cards 22, 24, 26, 28 and 30. Initially only the backs of the cards 22-30 are displayed. A first Bonus Poker Hand 32 with five cards 34, 36, 38, 40 and 42 is displayed above the Base Poker Hand 20. A second Bonus Poker Hand 44 with five cards 46, 48, 50, 52 and 54 is displayed above the first Bonus Poker Hand. Only the backs of the cards comprising the first and second Bonus Poker Hands 32, 44 are initially displayed. The card backs of the Base Poker Hand 20, first Bonus Poker Hand 32 and second Bonus Poker Hand 44 bare different patterns so that it is easier for the player to spot and distinguish the differences between them. Generally the cards are dealt from “standard” fifty-two card decks which may also include jokers.

There is also displayed a window 56 identifying the game, such as in this case the poker game conventionally known as “Jacks Or Better”. There is another window 58 that displays and describes winning hands and a Contract or amount paid. A display window 60 indicates the bet amount and window 62 displays a payback percentage.

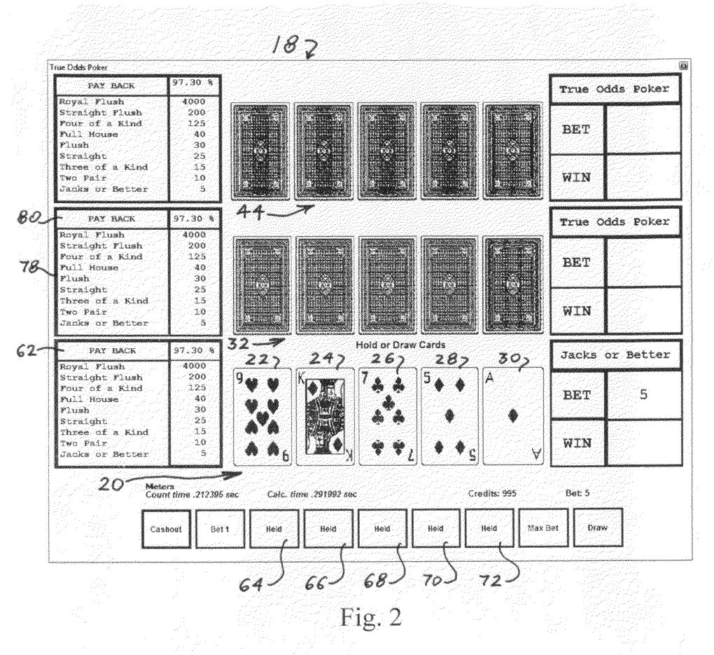

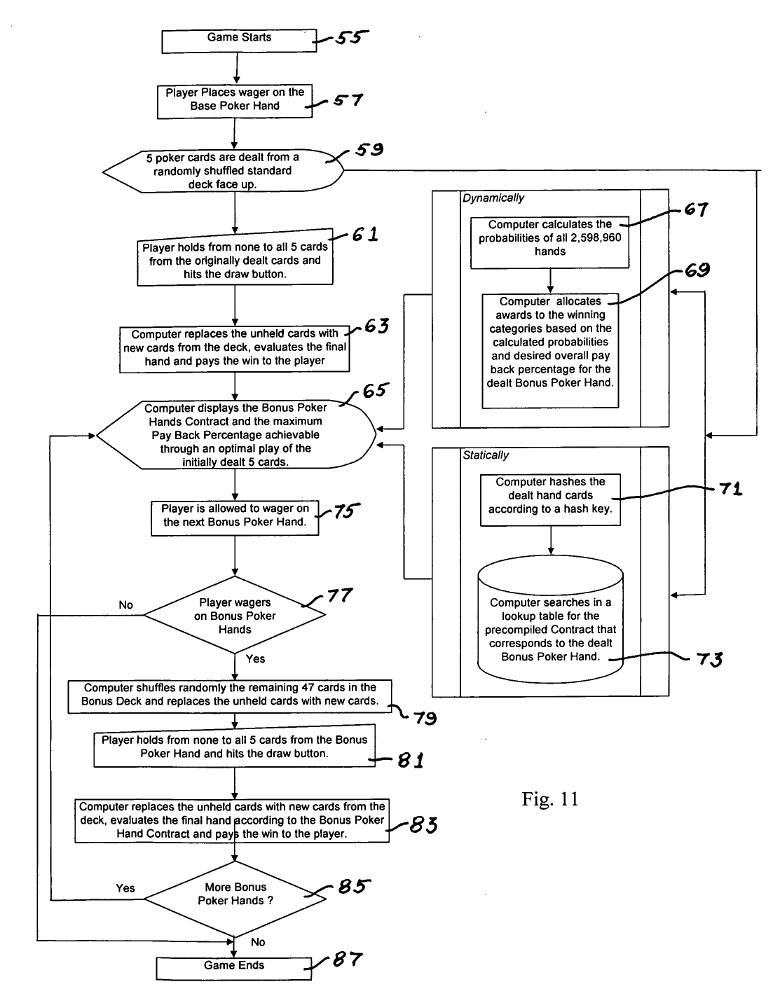

To illustrate a player playing the game, reference will be made to the screen displays in combination with the flow chart illustrated in FIG. 11. The video screen 18 initially appears to the player as seen in FIG. 1. The player inserts money into the game at step 55 in FIG. 11. At step 57 the player places his wager on the Base Poker Hand 20. It is assumed, that the player wagers 5 credits which is displayed in window 60. At this point as there are no cards revealed all the decks have equal probabilities and the Contracts for all the hands look exactly the same. At step 59 the game computer (not illustrated) deals the five cards 22-30 face up from a randomly shuffled standard deck of cards as illustrated in FIG. 2.

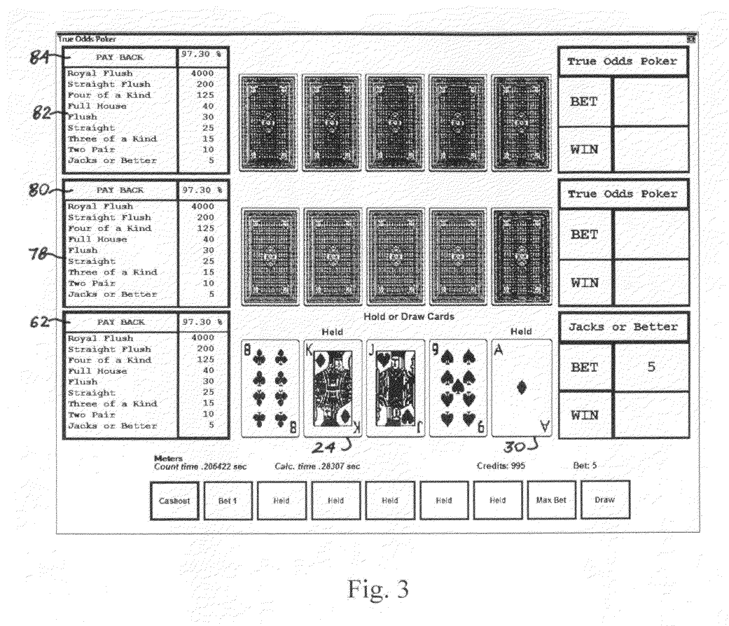

At step 61 the player holds from none to five of the originally dealt cards 22-30 by depressing hold buttons 64, 66, 68, 70, and 72 on the video game designating which cards he wants to hold. He then depresses a draw button 74 and at step 63 the computer replaces the cards not held with new cards from the randomly shuffled deck as seen in FIG. 3. The computer evaluates the final hand and awards the player according to the Contract 58. The amount won, if any, is displayed in payout window 76.

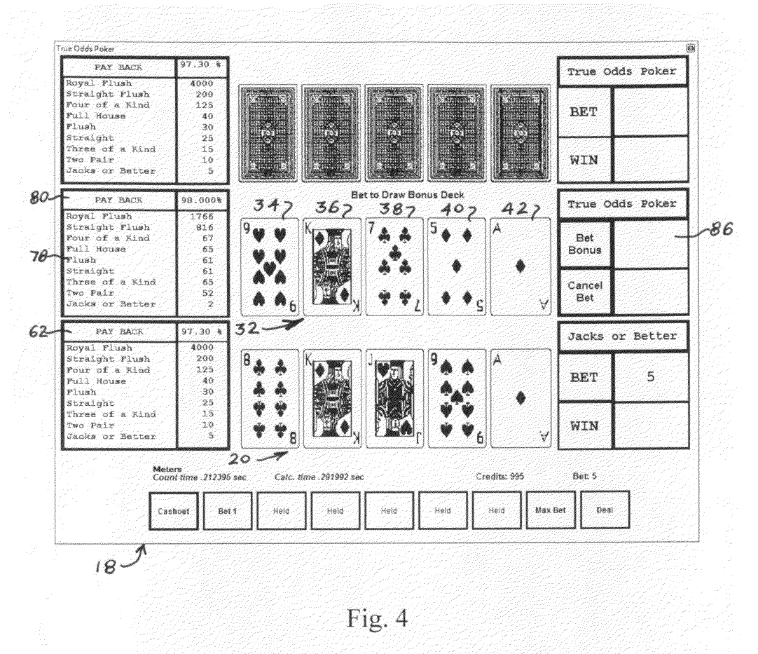

As seen in FIG. 4 and as described in FIG. 11, at step 65, as soon as the Base Poker Hand 20 is completed, the computer displays the first Bonus Poker Hand 32 comprised of cards 34-42 and the first Bonus Poker Hand Contract at window 78. Also displayed at window 80 is the maximum pay back percentage achievable through an optimal play of the first Bonus Poker Hand. At step 67, the computer, utilizing a powerful central processing unit (“CPU”) and fast poker evaluation algorithms, starts evaluating all possible 2,598,960 combinations in all possible permutations of the remaining 47 cards in the first Bonus Poker Hand deck and all possible 32 combinations in which the initial five cards 34-42, can be held to calculate the probabilities of the winning categories. At step 69, the CPU allocates awards to the winning categories or hands based on the calculated probabilities and desired overall payback percentage for the dealt first Bonus Poker Hand 32. The time to perform this calculation is approximately between 2-2.5 seconds. Once the CPU has finished the evaluation of the drawn five card hand for the first Bonus Poker Hand 32 and the Second Bonus Poker Hand 44 and adjusts the Contract or rewards in the players favor so that the Contract exceeds the pay back percentage of the Contract 58 in the Base Poker Hand 20, it is displayed in the window 78 for the first Bonus Poker Hand Contract or window 82 for the second Bonus Poker Hand Contract.

The advances in Electronic Gaming Devices (EGM) as described afore make it possible for the EGM to calculate the probabilities of all 2,598,960 hands for any starting five card game (the initial condition), or alternatively retrieve the appropriate Contract and payback percentage from precompiled and stored data (as seen in steps 71 and 73) in far less time than the human time limitations over playing a traditional draw video poker game. In step 71 the CPU hashes the remaining cards in the first and second Bonus Poker Hands and searches in a lookup table for the precompiled Contract that corresponds to the first and second Bonus Poker Hands. Using statically or dynamically generated Contracts and payback percentages is entirely transparent to the player. The manufacturer is free to choose the more efficient implementation of statically or dynamically generated Contracts as the manufacturer deems appropriate.

The dynamically calculated odds can be calculated in several ways. One such way is to use the following well-known formula in linear programming (Operational Research):

$${\sum }_{j = 1}^{n} {c}_{j} {x}_{j} -> max$$

### Subject to:

$${x}_{j} \geq 0 , j = 1 , 2 , … , n . \\ {\sum }_{j = 1}^{n} {a}_{ij} {x}_{j} \leq {b}_{i} , i = 1 , 2 , … , m .$$

### Where

j stands for the hand categories to be rewarded (Royal Flush, Straight Flush, 4 of a kind, Full House, Flush, Straight, 3 of a Kind, 2 Pair, Jacks or Better, etc.);
i represents all 32 possible ways that 5 cards can be held;
cⱼ represents the constant total number of hands in the deck (i.e. 4 Royal Flushes, 36 Straight Flushes, 624 Four of a kinds, 3744 Full Houses, 5108 Flushes, 10200 Straights, 54912 Three of a Kind, 123552 Two Pairs and 337,920 hands of Jacks or Better);
xⱼ represents the unknown prizes for each hand to be determined;
aᵢⱼ is the matrix of probabilities for each hand category j and each possible hold pattern;
bᵢ are the restrictions that determine the minimum casino hold percentage (i.e 98%, 99% etc.).

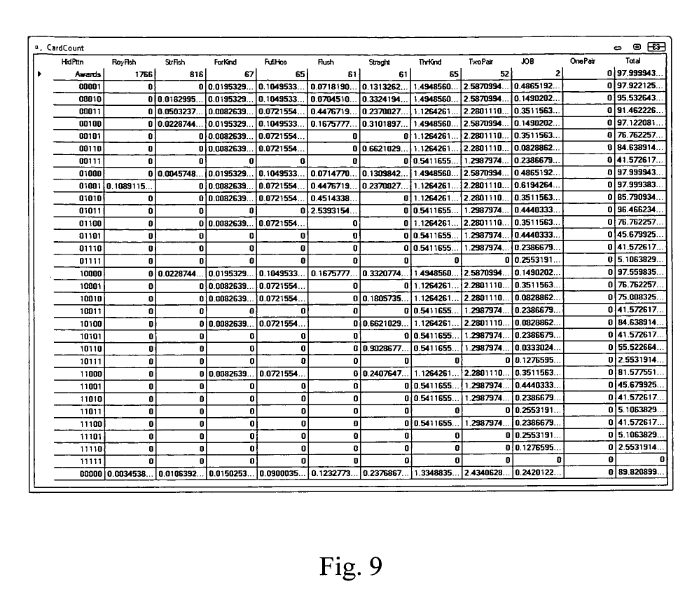

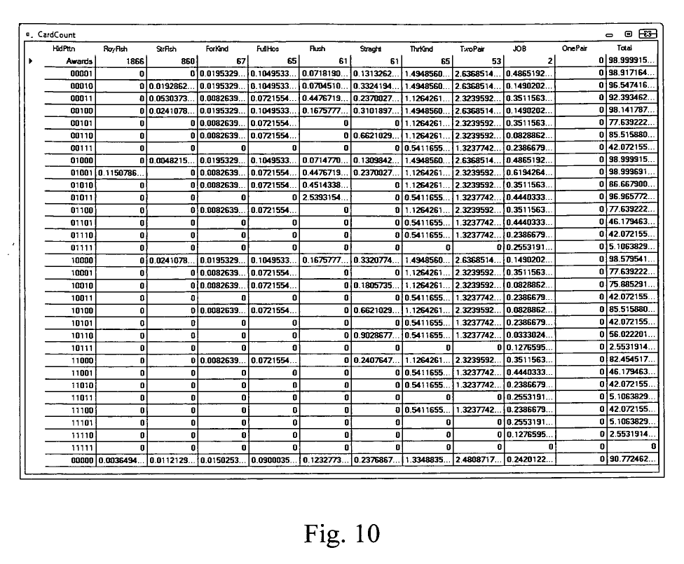

The tabulated results of these calculations are illustrated in FIGS. 9 and 10. The formula calculates the pay table as the summation of constants times the number of awards. In terms of the casino operator the problem is looking at any dealt hand to determine such awards that will yield the maximum expected value to the player in a standard poker game (i.e. in a Jacks or Better Poker game 4 Royal Flushes times the Royal Flush award, plus 36 Straight Flushes times the Straight Flushes award, etc). But as a for profit establishment the casino is concerned that there is no hold strategy that will break the house (i.e. the constraints will not allow any set of awards to exceed a preset boundary).

There are several rules that should be followed. One is that the pay back percentage cannot exceed 100%. Another is that the maximum pay back percentage for the optimum played bonus hands increases with each bonus hand. Thus the pay back percentage for the First Bonus Poker hand may be 98% and the maximum pay back percentage for the Second Bonus Poker hand may be 99%. However, the maximum payback percentage cannot exceed 100% or the casino will be paying back more than it takes in.

As illustrated in FIGS. 9 and 10, the odds of achieving a specific hand for each hold pattern of the initially dealt five cards is shown. For example in FIG. 9, which is the odds for the first Bonus Poker Hand, it is seen that if the player holds the second and fifth from the left cards (i.e. the king of diamonds and the ace of diamonds), the odds of drawing a royal flush are 0.108911 percent. The odds of drawing a straight flush are zero as holding these cards cannot result in a straight flush regardless of what cards are drawn. The odds of drawing the other winning hands are indicated and the total percentage for all the winning hands is 97.999383. By the player being knowledgeable, he can decide which cards should be held to increase the possibility of drawing a winning hand and receiving the greatest payback. It will be seen by comparing the odds in FIGS. 9 and 10 that the odds are different due to the extra percent and the integer restriction on the awards. If fractional awards are paid, then there will be an increase in the Contract by a fractional multiplier representing the increased payback percentage. But as we allow only integer rewards, to achieve the desired increased payback percentage the awards can only accommodate lump integer increments.

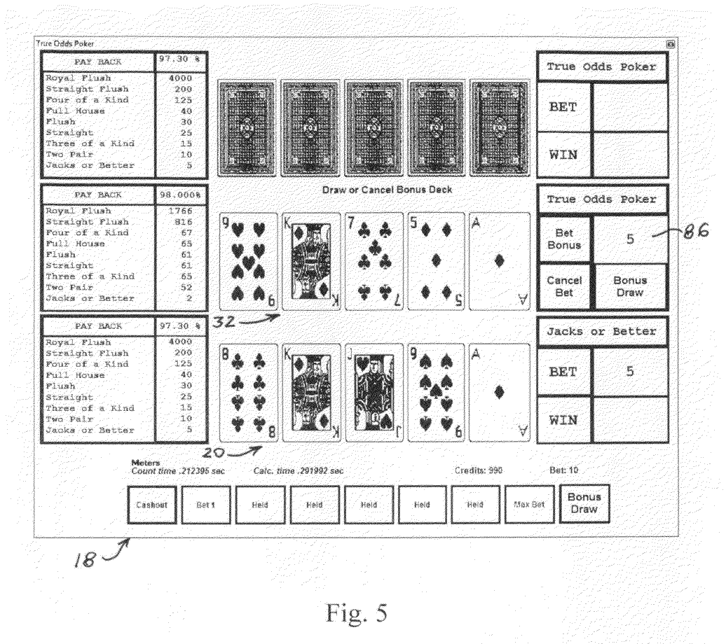

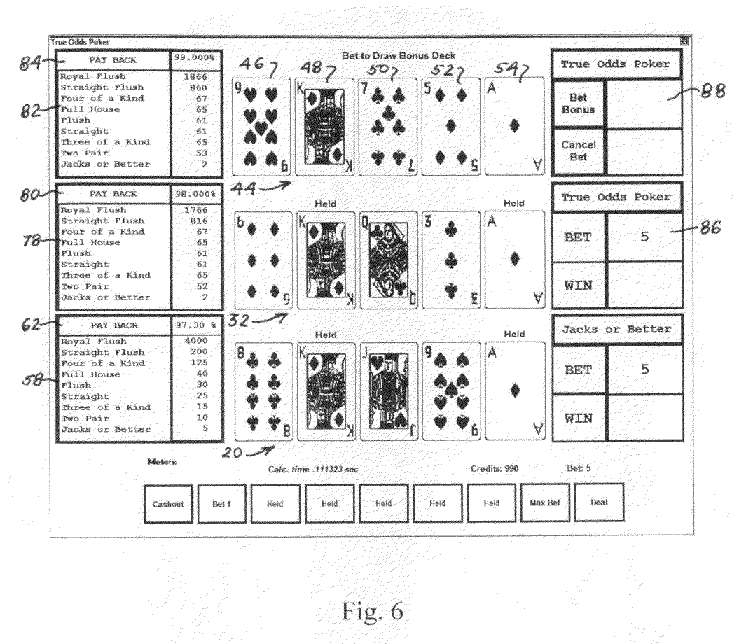

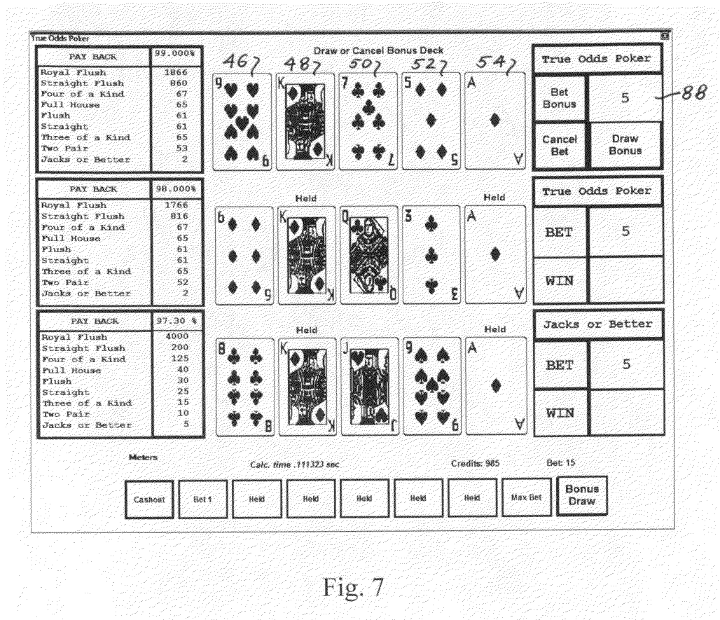

As seen in FIG. 4, once the Contracts or payback percentages are calculated or found in a table, they are displayed in windows 78 and 80 as described in Step 65. At Step 75 the player is allowed to bet on the first Bonus Poker Hand 32. If the player bets on the first Bonus Poker Hand at Step 77, the bet is shown in window 86 in FIG. 5. The CPU shuffles the remaining forty-seven of cards in the first bonus deck at Step 79. As seen in FIG. 6 and described at step 81 the player holds from none to all of the dealt cards and hits the draw button 74. At step 83 the CPU replaces the cards not held with new cards from the deck, evaluates the final hand according to the first Bonus Poker Hand Contract, and pays the amount won. As seen in FIG. 6, the player did not achieve a winning hand so there is no amount indicated in a win window 87 located below the bet window 86. At step 85 there is a decision block asking if there are additional bonus hands. If not, the game ends at step 87 and the player can begin anew at step 55. If there are more bonus hands available to be played, the player goes back to step 65 where the next bonus poker hand is displayed as seen in FIG. 7. The game continues until there are no more bonus poker hands to be played.

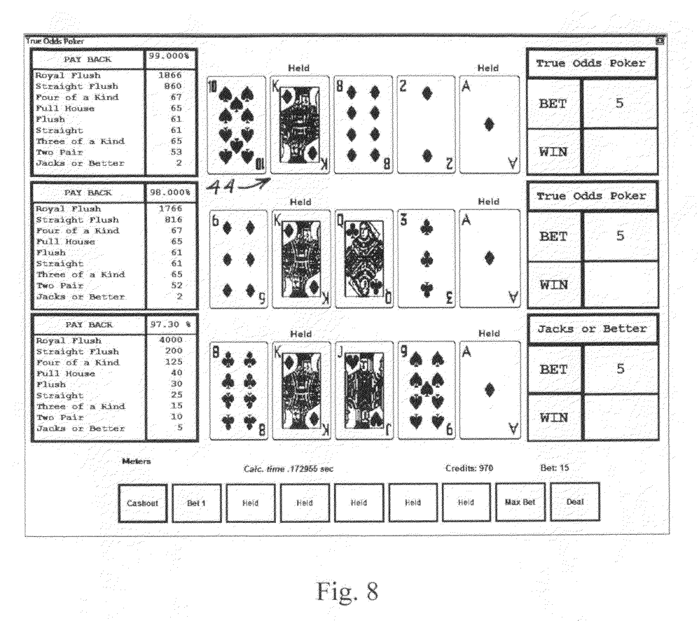

As described above, and seen in FIG. 7, if the second Bonus Poker Hand 44 is played, the winning hands and Contract are displayed in window 82. The maximum pay back percentage achievable through an optimal play of the second Bonus Poker Hand is displayed in window 84. The player is offered an option to bet on the second Bonus Poker Hand. If he places a bet, it is displayed in window 88, and he can hold one or more of cards 46-54 and draw replacement cards from those remaining in the second Bonus Poker Hand deck, which has been randomly and independently pre-shuffled. FIG. 8 displays the second Bonus Poker Hand after the player has selected the cards he wants to hold and the CPU dealt the replacement cards. After the hand is completed, the computer evaluates the player's win and pays it. The amount won is displayed in a second win window 89 below the second window bet 88.

As illustrated herein the first Bonus Poker Hand and second Bonus Poker Hand were duplicates of each other. This can be programmed into the game to always occur or the first and second Bonus Poker Hands can be generated independently of each other. Another alternative is to have the First and Second Bonus Poker hands the same as the Base Poker hand. The advantage of having the First and Second Bonus Poker hands the same as the Base Poker Hand is that the odds and Contracts are already calculated while the player is playing the Base Poker Hand. Also, as described herein, both Bonus Poker Hands are played in the same format of “Jacks or Better”. However, there is no requirement that all the hands be played in the same format, and in fact, different games for each of the hands are possible.

In the preferred embodiment after the player completes the draw of the Base Poker Hand, he will be allowed to place optional bets on the first and second Bonus Poker Hands only equal to the original bet as displayed in the window 60 to speed up the game, although this is not a material restriction to the implementation of the invention. In another embodiment the player is allowed to vary his bet in the first and second Bonus Poker Hands to either more than, equal to, or less than the Base Poker Hand 22.

There are other embodiments such as those listed below that can also be offered to the player:
(a) The First Bonus Poker hand and the Second Bonus Poker hand may have different formats from the Base Poker Hand, for example “Deuces Wild” and “Double Bonus Poker”.
(b) The player may be allowed to wager different amounts on the first and second Bonus Poker Hands from his bet on Base Poker Hand.
(c) The First and Second Bonus Poker Hands may award fractional credits which allow more precision for adjusting the pay back percentages.
(d) The First and Second Bonus Hands may not duplicate the dealt or final cards in the Base Poker Hand, but rather draw five cards from independently pre-shuffled bonus decks.
(e) The player may be offered to select any five cards from any multitude of cards that are displayed to him.
(f) A multitude of other criteria may be designed to the general linear programming problem as described above, for example decks with five instead of four Royal Flushes etc.
(g) A non-linear objective function can be applied to the above set of linear constraints.
(h) A Lagrangean relaxation to the linear constraints is another broad area for exploration.
(i) Hyperbolic (fractional) programming criteria can be used designed to the general linear programming problem as described above, that will yield a steady ratio between two sets of variables.
(j) Quadratic programming criteria also can be applied to the general linear programming problem as described above, that, for example, can minimize the risk.

Thus there has been provided a multitier video poker game with a bonus hand wagering system that fully satisfies the objects and advantages set forth herein. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A video poker game comprising:
a video display screen for displaying a first poker hand of at least five cards face up from a first standard deck;
player input means for allowing the player to select none, one or more of the face up cards from the first hand as cards to be held;
means for discarding from the first poker hand those cards not selected and replacing the discarded cards with face up cards from the first deck;
means for determining the final first hand and awarding the player a first amount based on a first pay table,
means for displaying a second poker hand of at least five cards face up from a second standard deck;
means for calculating a second pay table based on the probabilities of all possible hands that may be obtained from discarding none, one or more of the second poker hand's at least five cards, and replacing them with new cards from the second deck;
means for displaying the second pay table;
means for allowing the player to wager on the second hand after the player has observed the second hand and the second pay table;
means for allowing the player to play the second hand if a wager is made; and
means for determining the final second hand and awarding the player a second amount based on the second pay table.

2. The video poker game of claim 1 wherein the first pay table is based on the odds of obtaining a pair of jacks or better, two pairs, three of a kind, straight, flush, full house, four of a kind, straight flush and royal flush.

3. The video poker game of claim 2 wherein the second pay table is based on the odds of obtaining a pair of jacks or better, two pairs, three of a kind, straight, flush, full house, four of a kind, straight flush and royal flush but awards a better return than the first pay table for similar hands.

4. The video poker game of claim 1 and further providing means for displaying a pay back percentage for each poker hand based on the application of a mathematical optimization method that calculates the probabilities of all winning poker hands and provides the pay back percentage to the player based upon the mathematical optimization method used.

5. The video poker game of claim 4 wherein the pay back percentage for the second hand is greater than the pay back percentage for the first hand.

6. The video poker game of claim 1 and further comprising:
means for displaying a third poker hand of at least five cards face up from a third standard deck;
means for calculating a third pay table based on the probabilities of all possible hands that may be obtained from discarding none, one or more of the third poker hand's at least five cards, and replacing them with new cards from the third deck;
means for displaying the third pay table;
means for allowing the player to wager on the third hand after the player has observed the third hand and the third pay table;
means for allowing the player to play the third hand if a wager is made; and
means for determining the final third hand and awarding the player a third amount based on the third pay table.

7. The video poker game of claim 6 and further providing means for displaying a pay back percentage for each poker hand based on the total amount paid back to the player for the total amount wagered.

8. The video poker game of claim 7 wherein the pay back percentage for the third hand is greater than the pay back percentage for the second hand which is greater than the pay back percentage for the first hand.

9. A video poker game comprising:
a video display screen for displaying a first poker hand of at least five cards face up from a first standard deck;
player input means for allowing the player to select none, one or more of the face up cards from the first hand as cards to be held;
means for discarding from the first poker hand those cards not selected and replacing the discarded cards with face up cards from the first deck;
means for determining the final first poker hand and awarding the player a first amount based on a first pay table,
means for displaying a second poker hand of at least five cards face up from a second standard deck;
a second pay table based on the probabilities of all possible hands that may be obtained from discarding none, one or more of the second poker hand's at least five cards, and replacing them with new cards from the second deck;
means for displaying the second pay table;
means for allowing the player to wager on the second hand after the player has observed the second hand and the second pay table;
means for allowing the player to play the second hand if a wager is made; and
means for determining the final second hand and awarding the player a second amount based on the second pay table.

10. The video poker game of claim 9 wherein the second pay table is based on the odds of obtaining a pair of jacks or better, two pairs, three of a kind, straight, flush, full house, four of a kind, straight flush and royal flush.

11. The video poker game of claim 9 wherein the second pay table is a table of probabilities that is calculated and stored in a memory for later look up when the second poker hand is displayed.

12. The video poker game of claim 9 wherein the second pay table is dynamically calculated and is based on the odds of achieving a specific hand for various hold patterns of discarding none, one or more of the second poker hand's at least five cards.

13. The video poker game of claim 9 and further comprising means for determining a payback percentage for the first poker hand and a payback percentage for the second poker hand, the payback percentage for the second poker hand being greater than the payback percentage for the first poker hand.

14. The video poker game of claim 9 and further comprising:
means for displaying a third poker hand of at least five cards face up from a third standard deck;
a third pay table based on the probabilities of all possible hands that may be obtained from discarding none, one or more of the third poker hand's at least five cards, and replacing them with new cards from the third deck;
means for displaying the third pay table;
means for allowing the player to wager on the third hand after the player has observed the third hand and the third pay table;
means for allowing the player to play the third hand if a wager is made; and
means for determining the final third hand and awarding the player a third amount based on the third pay table.

15. The video poker game of claim 14 and further comprising means for determining a payback percentage for the first poker hand, a payback percentage for the second poker hand, and a payback percentage for the third poker hand, the payback percentage for the third poker hand being greater than the payback percentage for the second poker hand which is greater than the payback percentage for the first poker hand.

16. A method of playing a video poker game comprising:
a player making a first wager on a first poker hand;
displaying the first poker hand of at least five cards face up on a video screen;
the player selecting none, one or more of the face up cards from the first poker hand as cards to be held;
discarding from the first poker hand the cards not selected to be held and replacing the discarded cards with face up cards;
determining the final first poker hand and awarding the player a first amount based on a first pay table;
displaying a second poker hand of at least five cards all face up on the video screen;
providing a second pay table based on the probabilities of all possible final winning hands that can be made from the second poker hand while providing for discarding and replacing none, one or more of the face up cards;
displaying a payback amount based on the second pay table for each of the winning hands that may be made from the second poker hand;
giving the player the opportunity to wager on the second poker hand;
playing the second poker hand if a wager is made;
determining the final second poker hand and awarding the player a second amount based on the second pay table.

17. The method of claim 16 and the further step of determining a payback percentage for the first poker hand and a payback percentage for the second poker hand, the payback percentage for the second poker hand being greater than the payback percentage for the first poker hand.

18. The method of claim 17 and the further step of:
displaying a third poker hand of at least five cards all face up on the video screen;
providing a third pay table based on the probabilities of all possible final winning hands that can be made from the third poker hand while providing for discarding and replacing none, one or more of the face up cards;
displaying a payback amount for each of the winning hands that may be made from the third poker hand;
giving the player the opportunity to wager on the third poker hand;
playing the third poker hand if a wager is made;
determining the final third poker hand and awarding the player a third amount based on the third pay table.

19. The method of claim 18 and the further step of determining a payback percentage for the third poker hand which is greater than the payback percentage for the second poker hand.
